(19) United States
(12) Patent Application Publication
(10) Pub. No.: US 2010/0208277 A1
(43) Pub. Date: Aug. 19, 2010

(54) APPARATUS, METHOD AND PROGRAM FOR IMAGE PROCESSING

(75) Inventors: Kenji Murakami, Shiojiri-shi (JP); Iwane Ikeda, Nagano-shi (JP); Takashi Hyuga, Suwa-shi (JP); Kimitake Mizobe, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/707,505

(22) Filed: Feb. 17, 2010

(30) Foreign Application Priority Data
Feb. 17, 2009 (JP) 2009-033583

(51) Int. Cl. G06F 15/00

(52) U.S. Cl. 358/1.2

(57) ABSTRACT

An image processing apparatus includes a raster data creating unit that creates raster data representing an image including plural types of objects in response to input data representing the image, wherein the raster data includes high resolution raster data of a first pixel density and a low resolution raster data of a second pixel density lower than the first pixel density, and the raster data creating unit sets any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

### BACKGROUND

1. Technical Field

The present invention relates to an apparatus, a method and a program for image processing.

2. Related Art

In the related art, document data is created by a computer such as a personal computer and a digital camera. The document data includes various objects such as characters and bitmap images (e.g., photos). In order to output (display or print) an image according to the document data, the document data is converted (developed) to raster data. Herein, a development process at a first resolution and a development process at a second resolution higher than the first resolution are used, and bitmaps are converted to pattern numbers by using a look-up table in which the pattern numbers are assigned to bitmap patterns prepared in advance. Further, when resolution conversion processing is performed, a density value is calculated with reference to peripheral pixels (see JP-A-2001-136374 and JP-A-2002-176552).

However, when using high resolution raster data of a first pixel density and low resolution raster data of a second pixel density lower than the first pixel density, various problems may occur. For example, the capacity of a memory (storage area) required for storing a look-up table may be increased. Further, when a density value is calculated with reference to peripheral pixels, load may be increased.

### SUMMARY

An advantage of some aspects of the invention is to prevent problems from occurring when using high resolution raster data of a first pixel density and low resolution raster data of a second pixel density lower than the first pixel density.

The invention can be realized as the following forms or applications.

### Application 1

According to one aspect of the invention, there is provided an image processing apparatus including: a raster data creating unit that creates raster data representing an image including plural types of objects in response to input data representing the image, wherein the raster data includes high resolution raster data of a first pixel density and a low resolution raster data of a second pixel density lower than the first pixel density, and the raster data creating unit sets any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

According to the above configuration, in the image area of the objects of the type other than the characters, any one of the pixel values of the pixels of the high resolution raster data and the pixel values of the pixels of the low resolution raster data is set based on the variation of the colors. Herein, when the image has been represented by the high resolution raster data, the image can be represented by many colors as compared with the case in which an image in the same area has been represented by the low resolution raster data. Thus, according to the above configuration, when the pixel values of the pixels of the high resolution raster data have been set, the probability that a predetermined type of objects becomes excessively coarse can be reduced. When the pixel values of the pixels of the low resolution raster data have been set, the data amount necessary for representing the predetermined type of objects can be reduced.

### Application 2

In the image processing apparatus according to application 1, the raster data creating unit sets the pixel values of the pixels of the high resolution raster data with respect to objects such as characters.

According to the above configuration, the object of the character is represented by the first pixel of the first density (high resolution), so that the probability that the object of the character gets blurred can be reduced.

### Application 3

In the image processing apparatus according to application 1 or 2, the raster data creating unit sets the pixel values of the pixels of the high resolution raster data when an index value indicating magnitude of the variation of the colors is larger than a predetermined threshold value, and sets the pixel values of the pixels of the low resolution raster data when the index value is smaller than the predetermined threshold value.

According to the above configuration, the case of setting the pixel values of the pixels of the high resolution raster data can be distinguished from the case of the pixel values of the pixels of the low resolution raster data by setting the predetermined threshold value.

### Application 4

In the image processing apparatus according to application 3, the index value is a total number of the colors in at least a part of the plural pixels of the first pixel density, which correspond to one pixel of the second pixel density.

According to the above configuration, an appropriate case in which the variation of the colors is large can be employed as a first case.

### Application 5

In the image processing apparatus according to application 3, a range of colors represented by the raster data is divided in advance into a plurality of sub-ranges, and the index value is a total number of sub-ranges including at least one of the colors in at least a part of the pixels of the first pixel density, which correspond to one pixel of the second pixel density.

According to the above configuration, an appropriate case in which the variation of the colors is large can be employed as a first case.

### Application 6

In the image processing apparatus according to any one of applications 1 to 5, the image processing apparatus further includes a compression unit that compresses the high resolution raster data.

According to the above configuration, the high resolution raster data represents the object of the character, so that data can be compressed with high efficiency.

### Application 7

In the image processing apparatus according to any one of applications 1 to 6, in the high resolution raster data, at least two of the plural pixels, which correspond to one pixel of the second pixel density, represent colors different from each other.

According to the above configuration, the probability that the predetermined type of objects becomes coarse can be reliably reduced.

### Application 8

According to another aspect of the invention, there is provided an image processing system provided with the image processing apparatus according to any one of applications 1 to 7, and a printing apparatus that performs printing based on the raster data created by the image processing apparatus.

### Application 9

According to further another aspect of the invention, there is provided a method of creating raster data including: creating the raster data representing an image including plural types of objects in response to input data representing the image, wherein the raster data includes high resolution raster data of a first pixel density and a low resolution raster data of a second pixel density lower than the first pixel density, and the creating of the raster data includes setting any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

### Application 10

According to yet another aspect of the invention, there is provided a computer program that causes a computer to execute a process of creating raster data, the computer program product causing the computer to execute a function of creating the raster data representing an image including plural types of objects in response to input data representing the image, wherein the raster data includes high resolution raster data of a first pixel density and a low resolution raster data of a second pixel density lower than the first pixel density, and the function of creating the raster data includes setting any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

Hence, the invention can be realized in various forms. For example, the invention can be realized in a form such as an image processing method and apparatus, a computer program for executing the functions of the method and the apparatus, and a recording medium on which the computer program is recorded.

### BRIEF DESCRIPTION OF THE DRAWINGS

The invention will be described with reference to the accompanying drawings, wherein like numbers reference like elements.

FIG. 1 is a block diagram illustrating an image processing system according to one embodiment of the invention.

FIG. 2 is a schematic view illustrating the creation of raster data.

FIG. 3 is a schematic view illustrating the synthesis of raster data.

FIG. 4 is a flowchart illustrating the sequence of creating (determining a pixel value) raster data.

FIG. 5 is a schematic view illustrating one example of determining a pixel value.

FIG. 6 is a schematic view illustrating another example of determining a pixel value.

FIG. 7 is a schematic view illustrating another example of determining a pixel value.

FIG. 8 is a schematic view illustrating another example of determining a pixel value.

FIGS. 9A and 9B are schematic views illustrating an example of determining a pixel value when a threshold value is 2.

FIGS. 10A to 10C are schematic views illustrating another embodiment of determining a pixel value.

FIGS. 11A and 11B are schematic views illustrating another embodiment of determining a pixel value.

FIGS. 12A and 12B are schematic views illustrating another embodiment of determining a pixel value.

### DESCRIPTION OF EXEMPLARY EMBODIMENTS

Hereinafter, embodiments of the invention will be described according to the following sequence.

### A. First Embodiment

### B. Second Embodiment

### C. Third Embodiment

### D. Fourth Embodiment

### E. Fifth Embodiment

### F. Modified Example

### A. First Embodiment

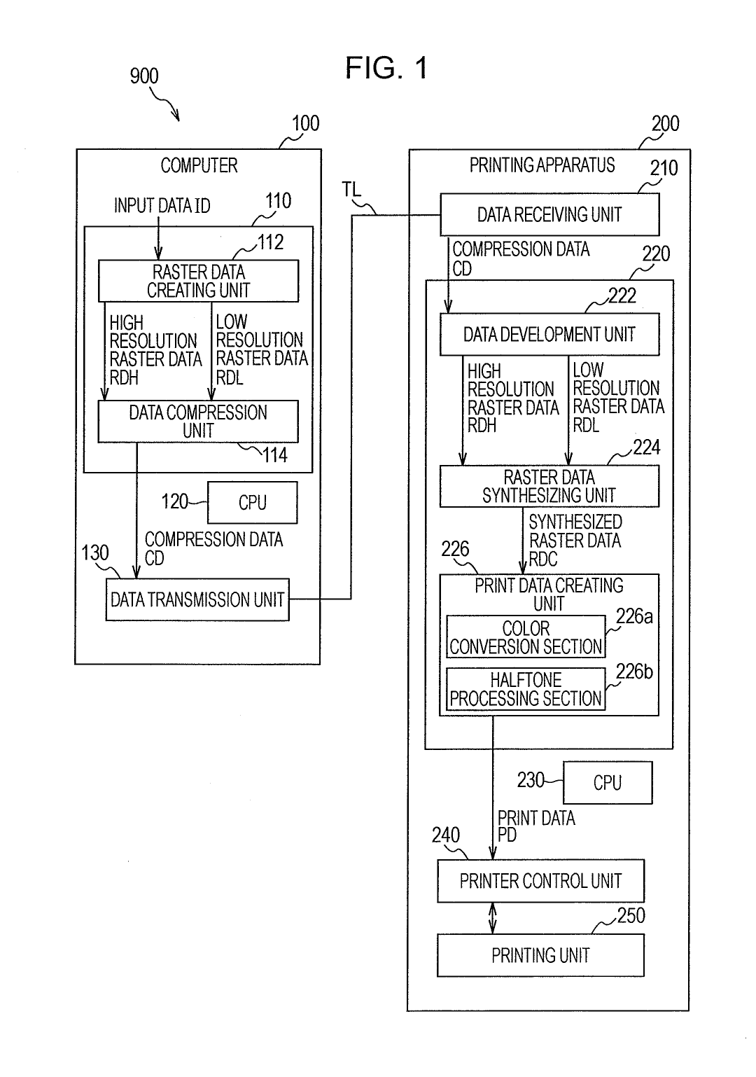

FIG. 1 is a block diagram illustrating an image processing system according to one embodiment of the invention. The image processing system 900 includes a computer 100 and a printing apparatus 200 connected to the computer 100 through a transmission path TL. In order to print an image represented by input data ID, the computer 100 develops the input data ID to create raster data. The “raster data” denotes data that represents an image by determining gradation values in pixel units. The printing apparatus 200 prints the image in response to the raster data received from the computer 100. The transmission path TL may employ various data communication lines such as USB cables and wired or wireless network.

The computer 100 includes a RAM 110, a CPU 120 and a data transmission unit 130. The RAM 110 stores a raster data creating unit 112 and a data compression unit 114. These processing units 112 and 114 denote computer program modules executed by the CPU 120. These modules 112 and 114 are developed in the RAM 110 from a non-volatile memory (not illustrated) such as a ROM and a hard disk drive. Hereinafter, the execution of a process by the CPU 120 according to the modules will be simply referred to as “the execution of the process by the module (e.g., the raster data creating unit 112)”. The data transmission unit 130 functions as an interface for connection to the transmission path TL.

The printing apparatus 200 includes a data receiving unit 210, a RAM 220, a CPU 230, a printer control unit 240 and a printing unit 250. The data receiving unit 210 functions as an interface for connection to the transmission path TL. The RAM 220 stores a data development unit 222, a raster data synthesizing unit 224 and a print data creating unit 226. These processing units 222, 224 and 226 denote computer program modules executed by the CPU 230. These modules 222, 224 and 226 are developed in the RAM 220 from a non-volatile memory (not illustrated) such as a ROM and a hard disk drive. Hereinafter, the execution of a process by the CPU 230 according to the modules will be simply referred to as “the execution of the process by the module (e.g., the raster data synthesizing unit 224)”. The print data creating unit 226 includes a color conversion section 226a and a halftone processing section 226b.

The printer control unit 240 controls the printing unit 250. The printing unit 250 functions as a printing mechanism that performs printing. The printing mechanism may employ various printing mechanisms such as printing mechanisms, which form an image by ejecting ink droplets onto a print sheet, and printing mechanisms which form an image by transferring and fixing toner onto a print sheet. According to the embodiment, the printer control unit 240 includes a dedicated electronic circuit.

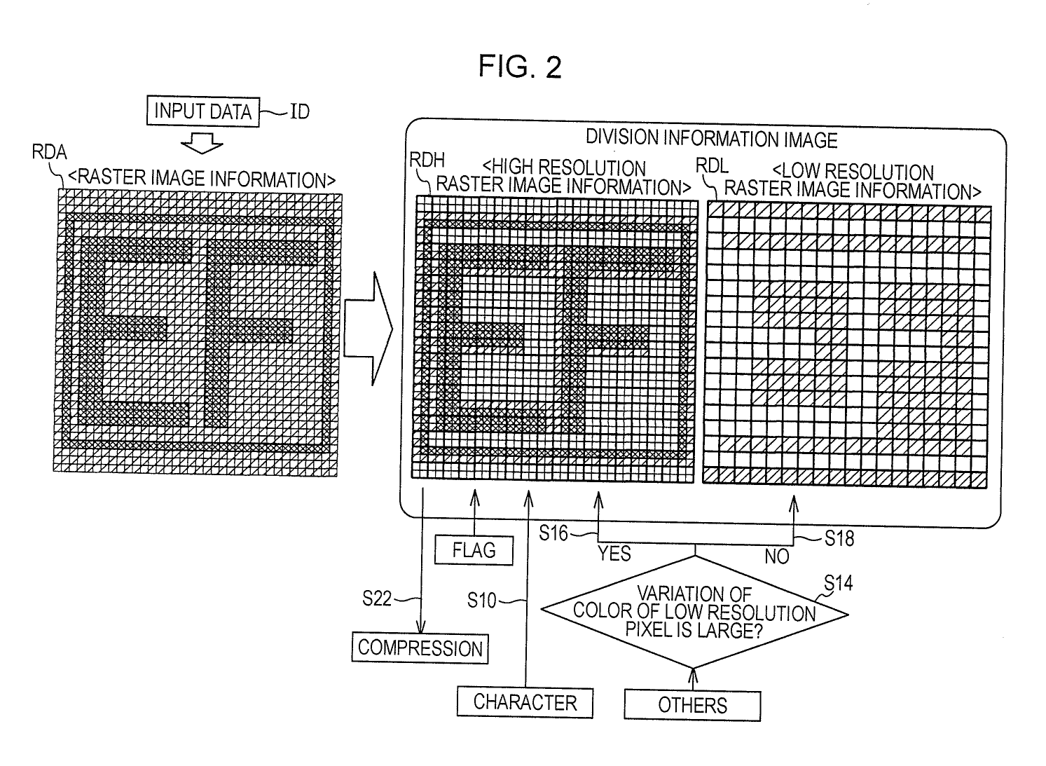

FIG. 2 is a schematic view illustrating the creation of the raster data (also referred to as “raster image information”). The raster data is created by the raster data creating unit 112 of the computer 100 (FIG. 1). According to the embodiment, the raster data creating unit 112 analyzes the input data ID, thereby creating the raster data representing an image indicated by the input data ID. The raster data includes high resolution raster data RDH and low resolution raster data RDL. The left side of FIG. 2 illustrates original raster data RDA which serves as a source of the raster data RDH and RDL. Further, the lower side of FIG. 2 illustrates the process of creating the raster data RDH and RDL.

According to the embodiment, the input data ID is PDL (Page Description Language) data described by a PDL. The PDL, for example, includes Postscript (a trademark of Adobe Systems Incorporated). Such PDL data includes one or more drawing commands. One drawing command represents one object to be drawn.

The object, for example, may include “characters”, “bitmap images” and “vector graphics other than characters”. The “characters” are a type of the “vector graphics”. The vector graphics other than characters, for example, include line drawings or graphs. Hereinafter, the vector graphics other than characters will be referred to as “vector graphics of an image”, and an object other than characters among objects represented by the vector graphics will be referred to as “an object of an image”. Further, an object of a bitmap image will be referred to as a “bitmap image object” or will be simply referred to as a “bitmap object”.

The input data ID (PDL data) can be created by a document creation application (not illustrated) operating in the computer 100. Further, the input data ID may be supplied to the computer 100 from another data processing apparatus (not illustrated).

The raster data creating unit 112 (FIG. 1) can specify pixel values of each pixel with high resolution by high resolution rasterization according to the input data ID (PDL data). The original raster data RDA illustrated in the left side of FIG. 2 indicates the specified pixel values. In the same manner, the raster data creating unit 112 can specify pixel values of each pixel with low resolution by low resolution rasterization according to the input data ID (PDL data) (not illustrated).

Further, the raster data creating unit 112 creates the high resolution raster data RDH and the low resolution raster data RDL by using the specified pixel values of each pixel with high resolution (details will be described later). As described above, the original raster data RDA is divided (analyzed) into the high resolution raster data RDH and the low resolution raster data RDL. Further, the raster data creating unit 112 may directly create the high resolution raster data RDH and the low resolution raster data RDL from the input data ID, without creating the original raster data RDA.

The high resolution raster data RDH and the low resolution raster data RDL indicate the same image area, which is represented by the input data ID, at resolutions (pixel densities) different from each other. The data RDH and RDL represent as a whole an image indicated by the input data ID. According to the embodiment, pixel density of the high resolution raster data RDH is a 2400 dpi and pixel density of the low resolution raster data RDL is a 1200 dpi. If one low resolution pixel is selected, an area of (2×2) high resolution pixels included in the low resolution pixel is determined (it can be said that these high resolution pixels correspond to the low resolution pixel). Meanwhile, if one high resolution pixel is selected, one low resolution pixel including the high resolution pixel is determined (it can be said that the low resolution pixel corresponds to the high resolution pixel). The expression that “a plurality of pixels (of a first pixel density) correspond to one pixel of a second pixel density” according to the appended claims means that the pixels of the first pixel density are located in an area corresponding to one pixel of the second pixel density. In contrast, the expression that “one pixel of the second pixel density corresponds to one pixel of the first pixel density” means that one pixel of the first pixel density is located in the area corresponding to one pixel of the second pixel density. Further, pixel density of the original raster data RDA is identical to that of the high resolution raster data RDH.

According to the embodiment, the outline of the creation of the high resolution raster data RDH and the low resolution raster data RDL is as follows.

1) in relation to a part representing an object of characters in an image, the raster data creating unit 112 (FIG. 1) sets pixel values in pixels of the high resolution raster data RDH (Step S10 of FIG. 2). The raster data creating unit 112 determines pixel values of high resolution by rasterizing characters at the high resolution.

2) in relation to other parts in the image, the raster data creating unit 112 (FIG. 1) performs the following processes with respect to respective low resolution pixels. First, the raster data creating unit 112 specifies the total number of colors in the pixel of low resolution (Step S14). The total number of colors denotes the total number of colors of each pixel position of high resolution (according to the embodiment, the total number of colors of (2×2) high resolution pixels). As the total number of colors is large, it can be understood that variation of colors in the pixel of the low resolution is large. When the total number of colors (the variation of colors) is large, the raster data creating unit 112 sets pixel values in four pixels of the high resolution raster data RDH (Step S16). When the total number of colors (the variation of colors) is small, the raster data creating unit 112 sets pixel values in one pixel of the low resolution raster data RDL (Step S18). Further, the raster data creating unit 112 can determine the pixel values of the high resolution by rasterizing the input data ID (object) at the high resolution. In the same manner, the raster data creating unit 112 can determine pixel values of low resolution by rasterizing the input data ID (object) at low resolution.

In relation to a part (i.e., a part not representing the object) representing only a background in the image, the raster data creating unit 112 (FIG. 1) sets pixel values in the low resolution raster data RDL because the variation of colors is small. Normally, a background color is the brightest white.

In relation to a part representing the bitmap object in the image, raster data for setting pixel values according to the variation of colors is determined. For example, when the bitmap object in the input data ID is represented by pixel density lower than the pixel density of the high resolution raster data RDH, the variation of colors in the image of the low resolution tends to be small. Thus, the pixel values can be set in the low resolution raster data RDL. When the bitmap object is represented by a high pixel density, the variation of colors can be large. Then, the pixel values can be set in the high resolution raster data RDH. Further, the raster data creating unit 112 can obtain the pixel value of the low resolution and the pixel value of the high resolution through resolution conversion processing of the bitmap object.

In relation to a part representing the vector graphics (the object of the image) other than the characters in the image, raster data for setting pixel values according to the variation of colors is determined (details will be described later).

Further, the raster data creating unit 112 (FIG. 1) specifies the type of an object of each part in the image with reference to the drawing command of the input data ID.

In FIG. 2, pixels, to which pixel values have been set, are hatched. The high resolution raster data RDH represents pixel values of parts, which represent characters in the image, and parts which represent relatively fine patterns in the image. The relatively fine pattern, for example, includes an edge or a fine line which is represented by vector graphics. The low resolution raster data RDL represents pixel values of parts which represent relatively coarse patterns in the image. The relatively coarse pattern, for example, includes a background or a solid area which is represented by vector graphics.

Further, according to the embodiment, flags are set in each pixel of the high resolution raster data RDH. The flag represents whether a pixel value has been set. For example, when the flag has a value of 1, it represents that the pixel value has been set in the pixel. When the flag has a value of 0, it represents that the pixel value has not been set in the pixel. In relation to a pixel position of the high resolution when the flag has a value of 0, a color is represented by a corresponding pixel of the low resolution raster data RDL. The corresponding pixel is a low resolution pixel including a position of a high resolution pixel. Further, the raster data creating unit 112 initializes the flag of each pixel to “0”. Then, when setting a pixel value, the raster data creating unit 112 sets the flag to “1”. Detailed description about the creation of each raster data RDH and RDL will be given later.

The data compression unit 114 illustrated in FIG. 1 compresses the high resolution raster data RDH (S22 of FIG. 2). Characters have been drawn in the high resolution raster data RDH. Thus, a plurality of pixels representing the same pixel value can be continued over a wide image range. Further, a plurality of pixels where pixel values have not been set can be continued over a wide image range. As a result, the data compression unit 114 can compress the high resolution raster data RDH with high efficiency by using simple compression such as run length encoding. According to the embodiment, the low resolution raster data RDL is not compressed. However, the low resolution raster data RDL may also be compressed.

The data compression unit 114 supplies the data transmission unit 130 with the whole (hereinafter, referred to as compression data CD) of the compressed high resolution raster data RDH and the low resolution image data RDL. The data transmission unit 130 transmits the compression data CD to the printing apparatus 200 through the transmission path TL.

The data receiving unit 210 supplies the data development unit 222 with the received compression data CD. The data development unit 222 develops (decompresses) the received compression data CD to obtain the high resolution raster data RDH and the low resolution raster data RDL. The raster data synthesizing unit 224 synthesizes the high resolution raster data RDH and the low resolution raster data RDL, thereby creating synthesized raster data RDC.

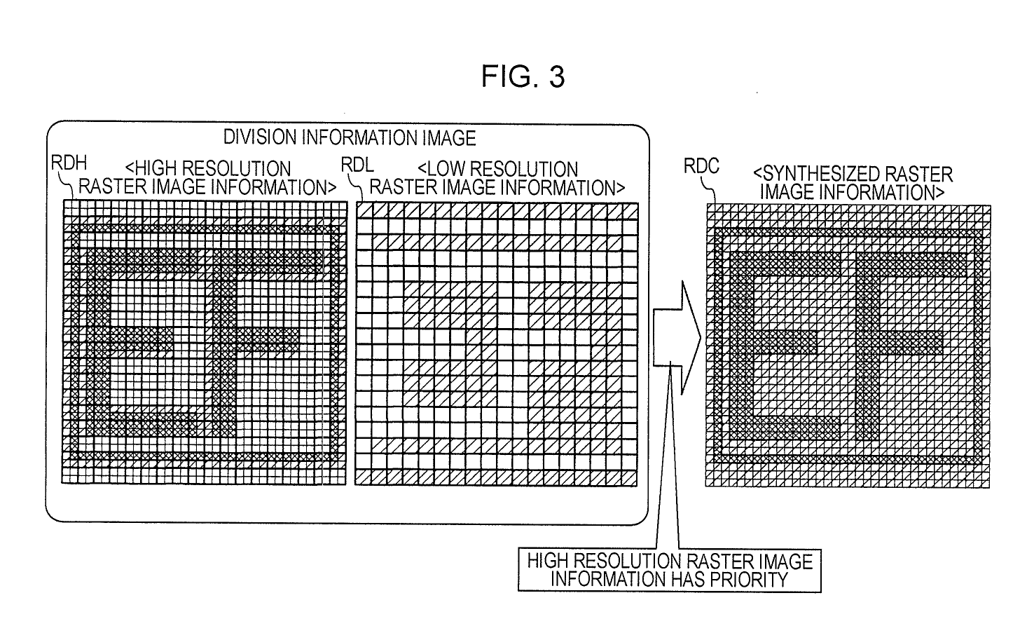

FIG. 3 is a schematic view illustrating the synthesis of the raster data. The synthesized raster data RDC represents an image indicated by the input data ID (FIGS. 1 and 2). Further, the pixel density of the synthesized raster data RDC is identical to that of the high resolution raster data RDH. The raster data synthesizing unit 224 synthesizes the raster data RDH and RDL after giving priority to the gradation values of the high resolution raster data RDH, thereby creating the synthesized raster data RDC. According to the embodiment, the raster data synthesizing unit 224 performs the following processes with respect to each pixel of the synthesized raster data RDC. First, the raster data synthesizing unit 224 checks a flag of a first corresponding pixel of the high resolution raster data RDH corresponding to one target pixel of the synthesized raster data RDC. The first corresponding pixel and the target pixel are located at the same position. Next, when the flag has a value of “1”, the raster data synthesizing unit 224 selects a pixel of the first corresponding pixel as a pixel value of the target pixel. Last, when the flag has a value of “0”, the raster data synthesizing unit 224 selects a pixel value of a second corresponding pixel in the low resolution raster data RDL as the pixel value of the target pixel. The second corresponding pixel includes the target pixel.

The print data creating unit 226 illustrated in FIG. 1 analyzes the synthesized raster data RDC to create print data PD. The color conversion section 226a converts pixel values of each pixel of the synthesized raster data RDC into gradation values of each ink used for the printing unit 250. For example, the pixel values of the synthesized raster data RDC are expressed by gradation values of R (red), G (green) and B (blue). Further, the printing unit 250 uses each ink of C (cyan), M (magenta), Y (yellow) and K (black). In such a case, the color conversion section 226a converts the gradation values of the R, G and B into the gradation values of C, M, Y and K. The halftone processing section 226b performs a halftone process according to the gradation values of each ink. Further, the halftone processing section 226b creates the print data PD according to the result of the halftone process.

The print data creating unit 226 supplies the printer control unit 240 with the created print data PD. The printer control unit 240 controls the printing unit 250 in response to the print data PD. In this way, the printing unit 250 prints the image. The whole of the print data creating unit 226, the printer control unit 240 and the printing unit 250 correspond to “a printing section”.

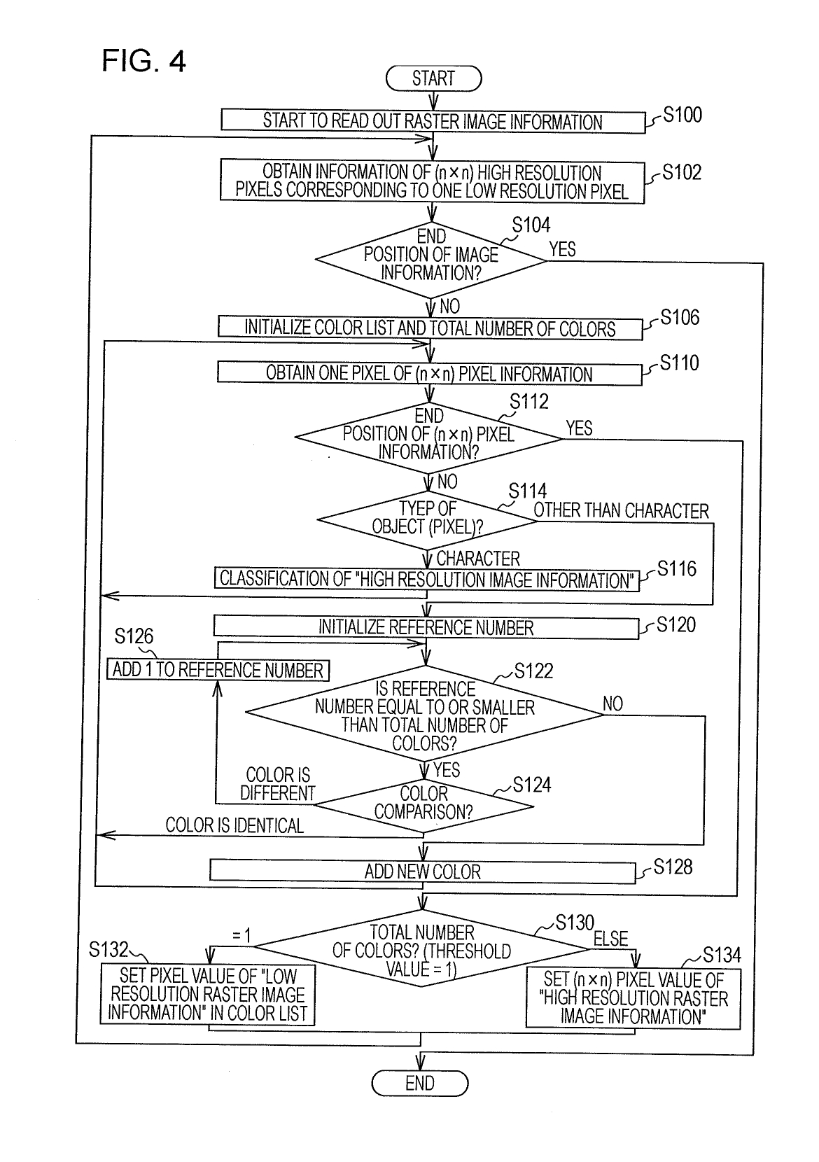

FIG. 4 is a flowchart illustrating the sequence of creating (determining a pixel value) the raster data RDH and RDL.

First, in Step S100, the raster data creating unit 112 (FIG. 1) starts to read out the original raster data RDA (FIG. 2). Next, in Step S102, the raster data creating unit 112 selects one low resolution pixel to obtain pixel values of (n×n) high resolution pixels corresponding to the low resolution pixel (n is an integer equal to or larger than 2 and has a value of 2 in the embodiment). Hereinafter, the selected one low resolution pixel will be referred to as a “target low resolution pixel”. The target low resolution pixel is selected in a predetermined sequence from the low resolution pixels. The raster data creating unit 112 performs processes of Step S106, S110, 112, 114, 116, 120, 122, 124, 126, 128, 130, 132 and 134, which will be described later, with respect to the respective low resolution pixels. When all the low resolution pixels have been completely processed (i.e., when the last position of raster image information has been completely processed) in the case of “Yes” in Step 104, the raster data creating unit 112 completes the creation of the raster data RDH and RDL.

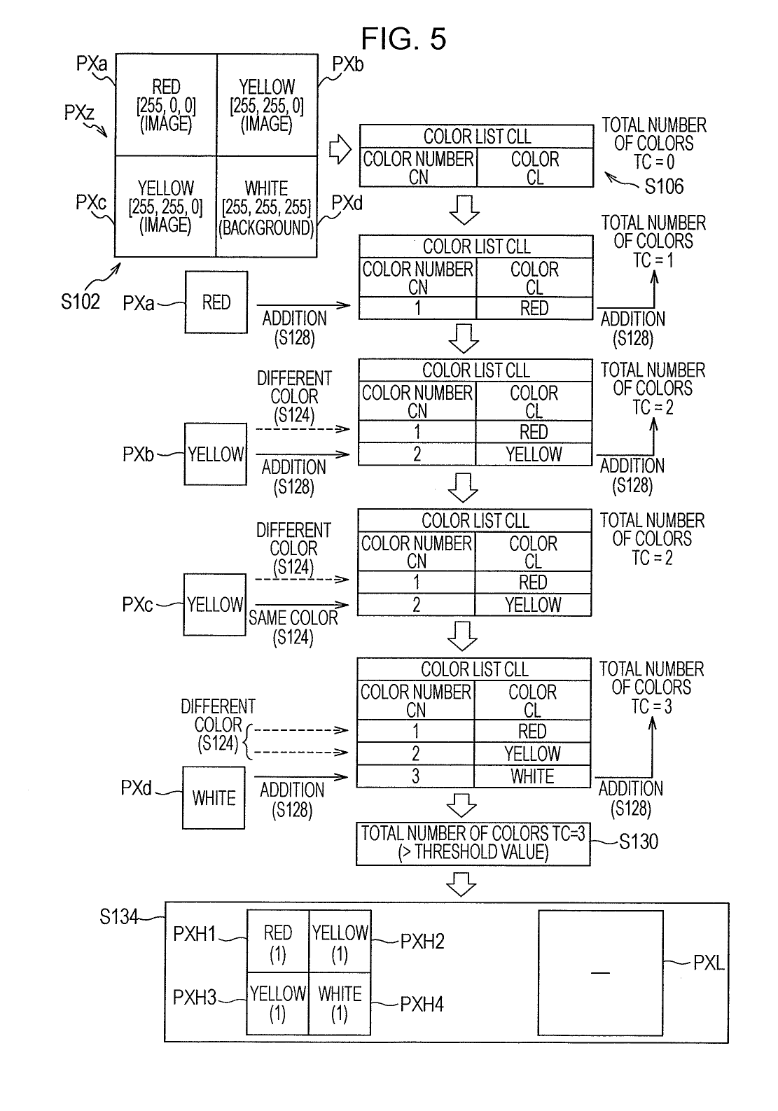

FIG. 5 is a schematic view illustrating an example of determining a pixel value. The left upper portion of FIG. 5 illustrates a target low resolution pixel PXz. In the target low resolution pixel PXz, four high resolution pixels PXa to PXd included in the target low resolution pixel PXz are illustrated. These pixels PXa to PXd correspond to the original raster data RDA of FIG. 2. In each of the pixels PXa to PXd, a color, a pixel value and the type of an object are illustrated. According to the embodiment, each pixel value is represented by gradation values of R, G and B. In the example of FIG. 5, three pixels PXa to PXc represent the object of an “image”. The fourth pixel PXd represents a “background”. As described above, the target low resolution pixel PXz represents an edge of the object of the image. Further, the target low resolution pixel PXz does not represent the object of a character but represents the object of the image. Each of the pixels PXa to PXd corresponds to the “corresponding pixel” according to the appended claims. Further, colors of the four pixels PXa to PXd are red, yellow, yellow and white, respectively. In addition, FIG. 5 illustrates variation in a color list CLL and the total number TC of colors, a low resolution pixel PXL, and high resolution pixels PXH1 to PXH4 (details will be described later).

In Step S106 of FIG. 4, the raster data creating unit 112 initializes the color list CLL and the total number TC of colors. In the upper portion of FIG. 5, the color list CLL and the total number TC of colors which has been initialized are illustrated. In the color list CLL, a color number CN corresponds to a color CL. As described later, in the color list CLL, colors represented by high resolution pixels other than characters are registered. The color number CN denotes an identifier for identifying registered colors (the color number CN is sequentially assigned from 1). The total number TC of colors denotes the total number of the registered colors. In Step S106, no colors are registered in the color list CLL and the color number TC denotes is “0”.

In Step S110, the raster data creating unit 112 (FIG. 1) selects one of the plural high resolution pixels included in the target low resolution pixel PXz and obtains the pixel value of the selected pixel. Hereinafter, the selected one high resolution pixel will be referred to as a “target high resolution pixel”. The target high resolution pixel is selected in a predetermined sequence from the plural high resolution pixels. The raster data creating unit 112 performs processes of Step S114, 116, 120, 122, 124, 126 and 128, which will be described later, with respect to the respective high resolution pixels included in the target low resolution pixel PXz. When all the high resolution pixels (four high resolution pixels PXa to PXd in the embodiment) have been completely processed (i.e., when the last pixel of the (n×n) pixels has been completely processed) in the case of “Yes” in Step 112, the raster data creating unit 112 moves to Step S130.

In Step S114 of FIG. 4, the raster data creating unit 112 (FIG. 1) specifies the type of an object of the target high resolution pixel. According to the embodiment, the specification is performed based on the input data ID.

When the type of the object is a “character”, in Step S116, the raster data creating unit 112 sets a pixel value of a pixel corresponding to the target high resolution pixel in the high resolution pixel raster data RDH (i.e., the target high resolution pixel is classified into a pixel having a pixel value to be set in the high resolution pixel raster data RDH). Next, the raster data creating unit 112 sets a flag of the pixel to “1” (this process corresponds to Step S10 of FIG. 2). Then, the raster data creating unit 112 returns to Step S110.

When the type of the object is not the “character” (e.g., when the type of the object is the object of the image or the background), the raster data creating unit 112 (FIG. 1) performs processes of Steps S120, 122, 124 and 126 of FIG. 4. Through these Steps, a color (also referred to as a “target color”) of the target high resolution pixel is registered in the color list CLL. When the same color has been previously registered in the color list CLL, additional registration of the target color is not performed. In order to determine whether the target color has been previously registered in the color list CLL, the raster data creating unit 112 compares the target color with the colors, which have been registered in the color list CLL, in the sequence of the color number CN one by one.

In Step S120, the raster data creating unit 112 (FIG. 1) initializes a reference number to “1”. The reference number indicates the color number CN of colors sequentially compared. Hereinafter, a color indicated by the reference number will be referred to as a “reference color”. Next, in Step S122, the raster data creating unit 112 determines whether the reference number is equal to or less than the total number TC of colors. When the reference number is larger than the total number TC of colors at the present time, it means that the target color has not been registered in the color list CLL. In such a case, in Step S128, the raster data creating unit 112 registers the target color in the color list CLL. In the example of FIG. 5, the first pixel PXa is initially selected as the target high resolution pixel (Step 110 of FIG. 4). In this step, since the reference number (1) is larger than the total number TC (0) of colors, the target color (red) is registered in the color list CLL (the color number CN has a value of 1). Then, the raster data creating unit 112 adds “1” to the total number TC of colors.

When the reference number is equal to or less than the total number TC of colors, in Step S124, the raster data creating unit 112 (FIG. 1) compares the target color with the reference color. In the example of FIG. 5, the second pixel PXb after the first pixel PXa is selected as the target high resolution pixel. Then, the target color (yellow) is compared with the reference color (color (red) in which the color number CN has a value of 1).

According to the embodiment, when a gradation value of the same color component is different between the target color and the reference color, it is determined that the target color is different from the reference color. When the target color is different from the reference color, the raster data creating unit 112 (FIG. 1) adds “1” to the reference number (S126), and then returns to Step S122. In relation to the second pixel PXb of FIG. 5, since a new reference number (2) is larger than the total number TC (1) of colors, in step S128, the raster data creating unit 112 adds the target color (yellow) to the color list CLL (the color number CN has a value of 2), and adds “1” to the total number TC of colors (the new total number TC of colors has a value of 2).

In the example of FIG. 5, the third pixel PXc next to the second pixel PXb is selected as the target high resolution pixel (S110 of FIG. 4). The raster data creating unit 112 (FIG. 1) compares the target color with the first reference color (red, CN=1), and then compares the target color with the second reference color (yellow, CN=2). The target color (yellow) is identical to the second reference color (yellow). When the target color is identical to the reference color, the raster data creating unit 112 does not change the color list CLL, and then returns to Step S110 from Step S124.

In the example of FIG. 5, the fourth pixel PXd after the third pixel PXc is selected as the target high resolution pixel (S110 of FIG. 4). Since the target color (white) is not registered in the color list CLL, the raster data creating unit 112 adds the target color (white) to the color list CLL and updates the total number TC of colors.

After all the high resolution pixels PXa to PXd of the target low resolution pixel PXz have been completely processed (Yes of Step S112 in FIG. 4), the raster data creating unit 112 (in FIG. 1) moves to Step S130. In Step S130, the raster data creating unit 112 compares the total number TC of colors with a threshold value. According to the embodiment, the threshold value is set to “1”.

When the total number TC of colors is larger than the threshold value, the raster data creating unit 112 (FIG. 1) determines the pixel values of plural pixels corresponding to the target low resolution pixel PXz among the pixels of the high resolution raster data RDH in Step S134. In the example of FIG. 5, the total number TC (3) of colors is larger than the threshold value (1). Thus, the raster data creating unit 112 determines the pixel values of four high resolution pixels PXH1 to PXH4 of the high resolution raster data RDH in Step S134. These pixels PXH1 to PXH4 correspond to the target low resolution pixel PXz. Further, the pixel values of these pixels PXH1 to PXH4 are set to be identical to the pixel values of the above-described high resolution pixels PXa to PXd, respectively. In addition, the raster data creating unit 112 set the flags of these pixels PXH1 to PXJ4 to “1”. In the lower portion of FIG. 5, colors and flags (numerical values in parentheses) are designated to the pixels PXH1 to PXH4. Then, in relation to the pixel PXL (pixel in the same position) corresponding to the target low resolution pixel PXz among the plural pixels of the low resolution raster data RDL, the raster data creating unit 112 does not set a pixel value. The low resolution pixel PXL corresponds to “the second pixel” according to the appended claims.

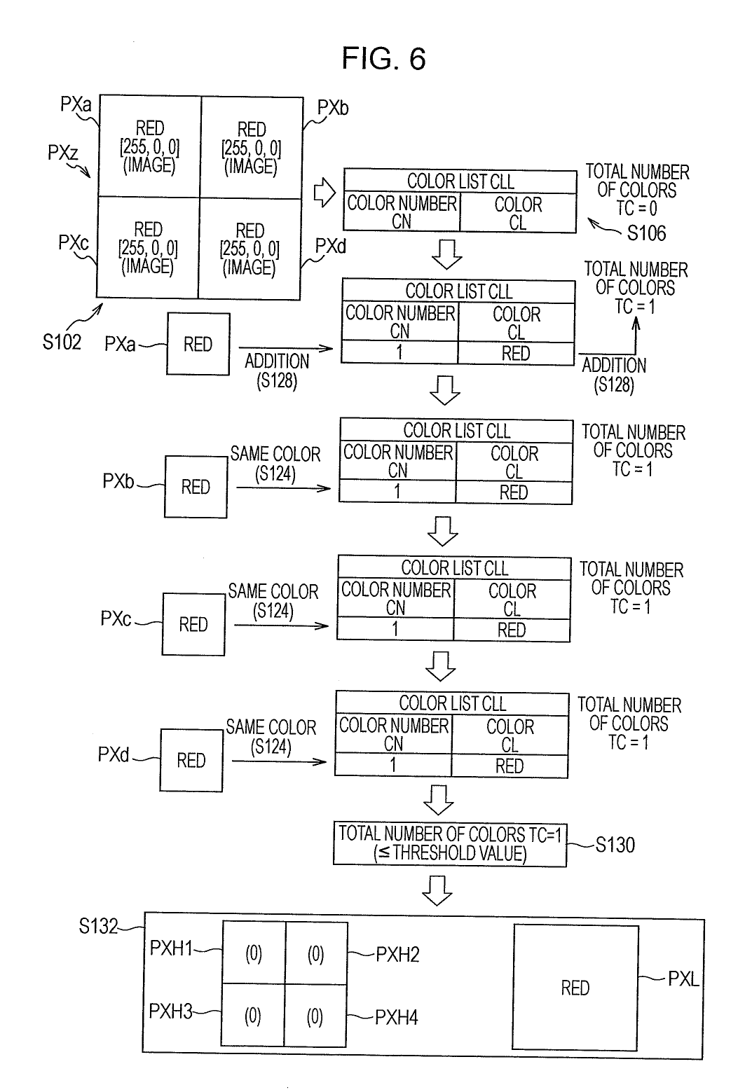

When the total number TC of colors is equal to or less than the threshold value (the total number TC of colors has a value of 1 in the embodiment), the raster data creating unit 112 sets the pixel value of the pixel PXL (pixel corresponding to the target low resolution pixel PXz) of the low resolution raster data RDL in Step S132. FIG. 6 is a schematic view illustrating such a case. FIG. 6 illustrates another example of determining a pixel value. The example of FIG. 6 is substantially identical to the example of FIG. 5, except that all four pixels PXa to PXd represent the object of the “image” and colors of the pixels PXa to PXd are red. As described above, the target low resolution pixel PXz represents a solid area of the object of the image. Further, the target low resolution pixel PXz does not represent the object of the character but represents the object of the image. Each of the pixels PXa to PXd corresponds to the “corresponding pixel” according to the appended claims.

Even in the example of FIG. 6, the color list CLL and the total number TC of colors are set according to the sequence of FIG. 4. As a result, one color (red) is registered in the color list CLL and the total number TC of colors is set to “1”. Since the total number TC (1) of colors is equal to or less than the threshold value (1), the raster data creating unit 112 (FIG. 1) determines the pixel value of the pixel PXL of the low resolution raster data RDL in Step S132 of FIG. 4 (the low resolution pixel PXL corresponds to “the second pixel” according to the appended claims). One color has been registered in the color list CLL. Therefore, the raster data creating unit 112 sets the pixel value of the pixel PXL as a value representing the color registered in the color list CLL. In relation to four pixels PXH1 to PXH4 of the high resolution raster data RDH, the raster data creating unit 112 does not set a pixel value and flags thereof are maintained at “0”.

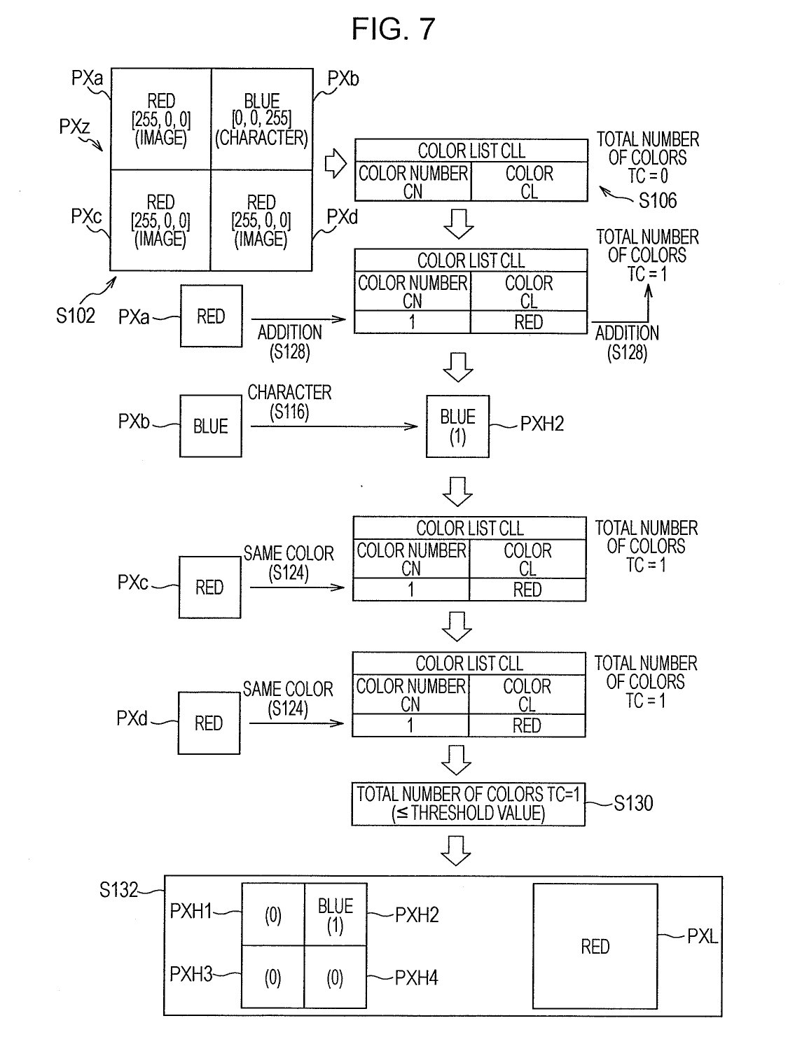

FIG. 7 is a schematic view illustrating another example of determining a pixel value. In the example, the second pixel PXb represents a “character” and the remaining three pixels PXa, PXc and PXd represent an “image”. The color of the second pixel PXb is “blue” and colors of the remaining three pixels PXa, PXc and PXd are “red”.

In the example of FIG. 7, since the second pixel PXb represents the character, the raster data creating unit 112 (FIG. 1) determines the pixel value of a high resolution pixel PXH2 corresponding to the second pixel PXb in Step S116 of FIG. 4, and sets a flag of the pixel PXH2 to “1”. The pixel value of the second pixel PXH2 is set to be identical to the pixel value of the second pixel PXb.

Further, even in the example of FIG. 7, the raster data creating unit 112 (in FIG. 1) sets the color list CLL and the total number TC of colors according to the sequence of FIG. 4. As a result, one color (red) is registered in the color list CLL and the total number TC of colors is set to “1”. Herein, the total number TC (1) of colors is equal to or less than the threshold value (1). Thus, the raster data creating unit 112 determines the pixel value of the pixel PXL (pixel corresponding to the target low resolution pixel PXz) of the low resolution raster data RDL in Step 5132 of FIG. 4. The pixel value of the pixel PXL is set as a value representing the color (red) registered in the color list CLL.

When creating the synthesized raster data RDC of the image part illustrated in FIG. 7, the raster data synthesizing unit 224 (FIG. 1) performs processes as follows. In relation to a pixel position (the second pixel PXH2) where the flag has been set to “1”, the raster data synthesizing unit 224 selects the pixel value of the second pixel PXH2 of high resolution. In relation to the three pixel positions (the pixels PXH1, PXH3 and PXH4) where the flag has been set to “0”, the raster data synthesizing unit 224 selects the pixel value of the low resolution pixel PXL. In this way, in relation to the high resolution pixel (the second pixel PXH2) representing the character, the pixel value of the high resolution raster data RDH is used. In relation to the high resolution pixels (the pixels PXH1, PXH3 and PXH4) representing the object of the image, the pixel value of the low resolution raster data RDL is used. In the example of FIG. 7, if the total number TC of colors of the pixels PXa, PXc and PXd other than characters is larger than the threshold value, pixel values are set in the high resolution raster data RDH with respect to these pixels PXa, PXc and PXd.

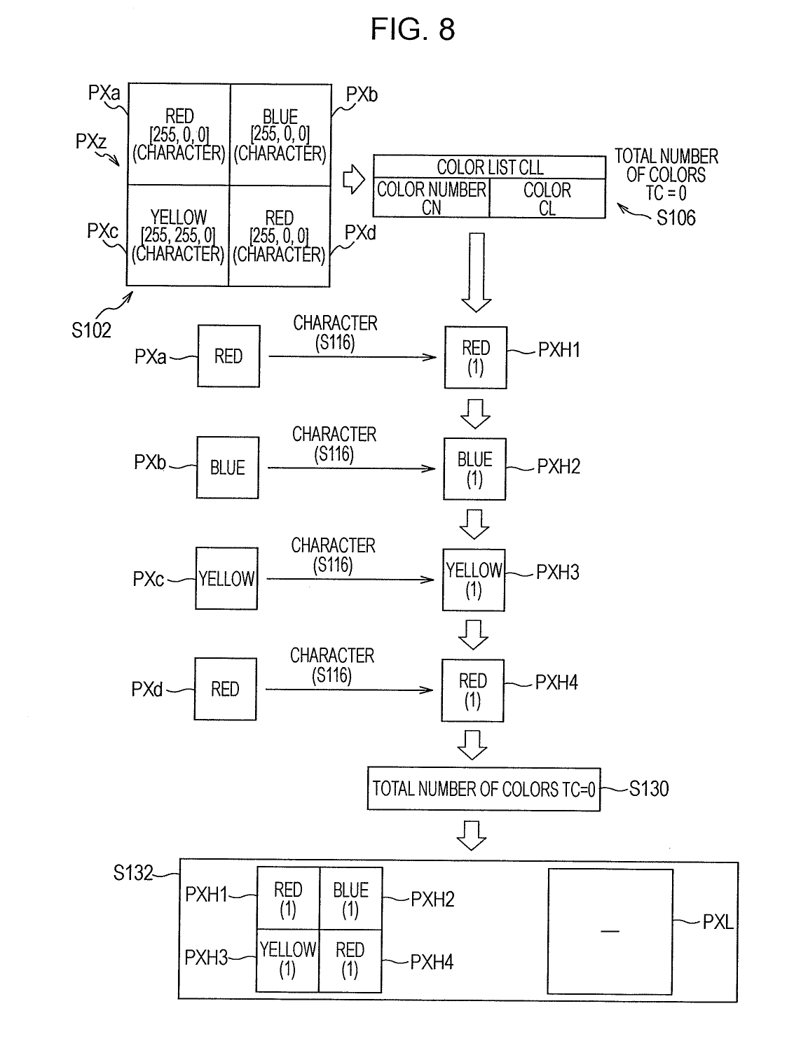

FIG. 8 is a schematic view illustrating another example of determining a pixel value. The example of FIG. 8 is substantially identical to the example of FIG. 5, except that all four pixels PXa to PXd represent the object of the “character”.

In such a case, in relation to the pixels PXa to PXd, the raster data creating unit 112 (FIG. 1) determines the pixel values of the high resolution pixels PXH1 to PXH4 in Step S116 of FIG. 4. Further, since the total number TC of colors has a value of “0”, the raster data creating unit 112 moves to Step S134 from Step S130 of FIG. 4. As a result, the pixel value of the low resolution pixel PXL is not set (the pixel values of the high resolution pixels PXH1 to PXH4 have been completely set in Step S116).

As described above, according to the embodiment, pixel values of a part of the plural pixels of the high resolution raster data RDH are determined and, particularly, pixel value of pixels representing the object of the character are determined (FIGS. 7 and 8). Consequently, the probability that the object of the character gets blurred can be reduced (S10 of FIG. 2 and S116 of FIG. 4).

Further, among the pixels of the low resolution raster data RDL, in relation to pixels corresponding to a low resolution pixel which does not represent the object of the character but represents the vector graphics of the image, pixel values are determined as follows. As illustrated in FIG. 5, when the total number TC of colors in one target low resolution pixel PXz is larger than the threshold value, the pixel values of the high resolution pixels corresponding to the target low resolution pixel PXz are determined (S134 of FIG. 4). When the total number TC of colors is larger than the threshold value, it means that variation of colors in the target low resolution pixel PXz (i.e., the low resolution pixel PXL) is large. In such a case, the pixel values of the high resolution raster data RDH are determined, so that it is possible to reduce the probability that a jaggy, thickening of a fine line or loss/lack of a fine line occurs, that is, the probability that vector graphics of the image become excessively coarse. Further, in order that plural high resolution pixels (e.g., PXH1 to PXH4 of FIG. 5) corresponding to one target low resolution pixel PXz (corresponding to the low resolution pixel PXL) include plural pixels (at least two pixels) representing colors different from each other, pixel values of the plural high resolution pixels are determined. Consequently, the probability that vector graphics of the image becomes coarse can be reliably reduced.

Further, as illustrated in FIG. 6, when the total number TC of colors is equal to or less than the threshold value, the pixel values of the low resolution pixel PXL corresponding to the target low resolution pixel PXz are determined (S132 of FIG. 4). When the total number TC of colors is equal to or less than the threshold value, it means that the variation of colors in the target low resolution pixel PXz (the low resolution pixel PXL) is small. In such a case, the pixel values of the low resolution raster data RDL are determined, so that it is possible to reduce the data amount necessary for representing the vector graphics of the image. Further, since the variation of colors is small, the fineness of the appearance of the vector graphics of the image can be prevented from being excessively reduced without using the high resolution pixels.

Further, according to the embodiment, the high resolution raster data RDH represents the object of the character. The object of the character is frequently represented by one color. Thus, plural pixels representing the same pixel value can be continued over a wide image range in the high resolution raster data RDH. As a result, the high resolution raster data RDH can be compressed with high efficiency. Further, as illustrated in FIG. 2, since a part representing a relatively coarse pattern in the image is represented by the low resolution raster data RDL, the data amount necessary for representing the relatively coarse pattern can be reduced. Further, although the bitmap object is represented by the low resolution raster data RDL, the fineness of the appearance can be prevented from being excessively reduced.

Further, according to the embodiment, the threshold value of the total number TC of colors has a value of 1. That is, when plural colors exist in the target low resolution pixel PXz, the plural colors are represented by the high resolution pixels (FIG. 5). Consequently, the raster data RDH and RDL is used, so that the image represented by the input data ID can be reliably reproduced.

### B. Second Embodiment

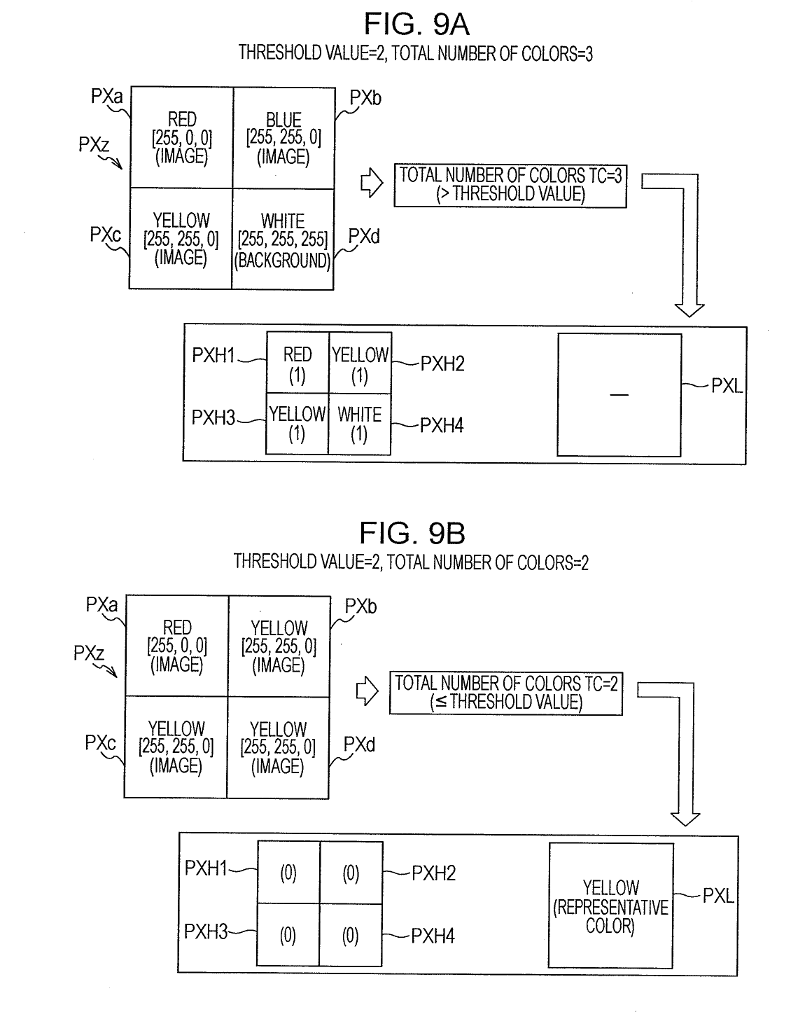

Differently from the first embodiment as illustrated in FIGS. 4 to 8, the threshold value of the total number TC of colors may be equal to or larger than 2. FIGS. 9A and 9B are schematic views illustrating an example of determining a pixel value when the threshold value is 2. Similarly to FIG. 5, FIG. 9A illustrates the target low resolution pixel PXz, the four high resolution pixels PXa to PXd, the total number TC of colors, the high resolution pixels PXH1 to PXH4 and the low resolution pixel PXL. The four high resolution pixels PXa to PXd are identical to the pixels illustrated in the example of FIG. 5, respectively. In such a case, the total number TC of colors has a value of “3” which is larger than the threshold value (2). Thus, the pixel values of the high resolution pixels PXH1 to PXH4 are determined. The determination of these pixel values corresponds to Step S16 of FIG. 2. Further, even in the embodiment, the plural pixel values of the high resolution pixels PXH1 to PXH4 are determined such that the high resolution pixels PXH1 to PXH4 include plural pixels (at least two pixels) representing colors different from each other.

FIG. 9B is a schematic view illustrating another example of determining a pixel value. The example of FIG. 9B is substantially identical to the example of FIG. 9A, except that the fourth pixel PXd represents the object of the “image” and the color of the fourth pixel PXd is yellow. In such a case, the threshold value of the total number TC of colors is “2” which is equal to or less than the threshold value (2). Thus, the raster data creating unit 112 (FIG. 1) determines the gradation value of the low resolution pixel PXL. The determination of the pixel value corresponds to Step S18 of FIG. 2. The gradation value of the pixel PXL is set as a value representing a representative color determined by a predetermined method. Various methods can be employed to determine the pixel value representing the representative color. According to the embodiment, a value obtained by rasterizing the input data ID at the low resolution is employed. Instead, it may be possible to employ a value (e.g., an average value, a mode value, a median value, a maximum value or a minimum value) represented by a function of respective pixel values of the high resolution pixels PXa to PXd included in the low resolution pixel PXL (the target low resolution pixel PXz). Such a function may be determined in each color component.

### C. Third Embodiment

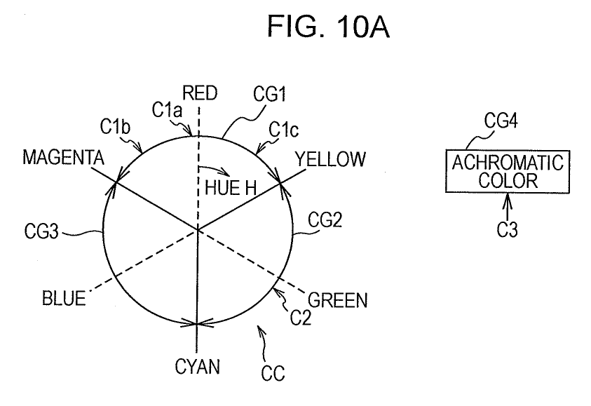

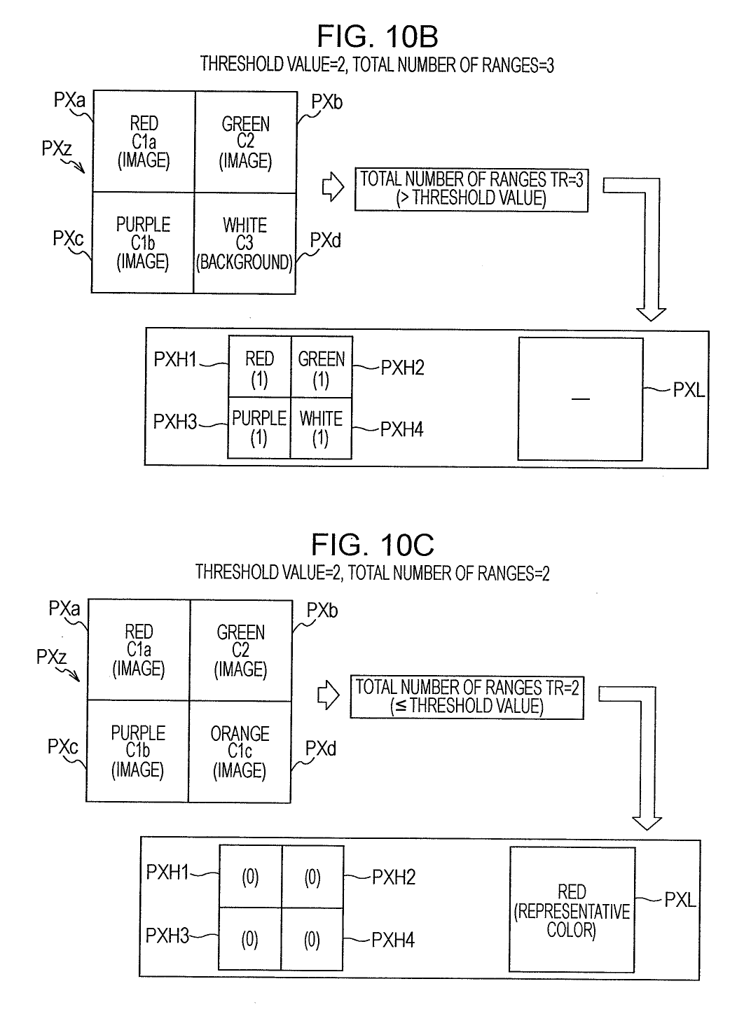

Differently from the previous embodiments, the raster data creating unit 112 (FIG. 1) may determine whether the variation of colors is large by using the total number of color ranges instead of the total number TC of colors. FIG. 10A is a schematic view illustrating an example of color ranges. FIG. 10A illustrates a color circle CC and an achromatic range CG4. According to the embodiment, the entire range of colors is divided into four sub-ranges CG1 to CG4. The three sub-ranges CG1 to CG3 are obtained by dividing the entire range of hues H into three. The three sub-ranges CG1 to CG3 represent red, green and blue, respectively. The fourth range CG4 represents achromatic color. The chromatic color is classified into any one of the three sub-ranges CG1 to CG3.

FIG. 10B is a schematic view illustrating an example of determining a pixel value. FIG. 10B illustrates the target low resolution pixel PXz, the four high resolution pixels PXa to PXd, the total number TR of ranges, the high resolution pixels PXH1 to PXH4 and the low resolution pixel PXL. The three high resolution pixels PXa to PXc each represent the object of the image, and the fourth pixel PXd represents the “background”. As described above, the target low resolution pixel PXz does not represent the object of the character but represents the object of the image. Further, the four high resolution pixels PXa to PXd represent red C1a, green C2, purple C1b and white C3, respectively. As illustrated in FIG. 10A, the red C1a and the purple C1b is included in the red range CG1. The green C2 is included in the green range CG2. The white C3 is included in the achromatic range CG4. In such a case, the total number TR of color ranges including at least one of the respective colors of the four high resolution pixels PXa to PXd has a value of 3 (CG1, CG2 and CG4).

According to the embodiment, the threshold value of the total number TR of color ranges is 2. Thus, in the example of FIG. 10B, the total number TR (3) of color ranges is larger than the threshold value (2). Consequently, the raster data creating unit 112 determines the pixel values of the high resolution pixels PXH1 to PXH4. The determination of these pixel values corresponds to Step S16 of FIG. 2. Further, even in the embodiment, the pixel values of the high resolution pixels PXH1 to PXH4 are determined such that the high resolution pixels PXH1 to PXH4 include plural pixels (at least two pixels) representing colors different from each other.

FIG. 10C is a schematic view illustrating another example of determining a pixel value. The example of FIG. 10C is substantially identical to the example of FIG. 10B, except that the fourth pixel PXd represents the object of the “image” and the color of the fourth pixel PXd is an “orange”. As illustrated in FIG. 10A, the orange C1c is included in the red range CG1. Thus, the total number TR of ranges has a value of “2” (CG1 and CG2) which is equal to or less than the threshold value (2). Consequently, the raster data creating unit 112 (in FIG. 1) determines the gradation value of the low resolution pixel PXL. The determination of the pixel value corresponds to Step S18 of FIG. 2. The gradation value of the pixel PXL is set similarly to the example of FIG. 9B.

Further, there occurs a case in which the target low resolution pixel PXz includes high resolution pixels representing the object of the character and high resolution pixels representing the object of the image. In such a case, similarly to the example of FIG. 7, the raster data creating unit 112 (FIG. 1) may calculate the total number TR of ranges by using the remaining high resolution pixels after excluding the high resolution pixels representing characters. Further, a sub-range of colors is not limited to the hue, and may be decided by other color components (e.g., brightness, chroma or each color component of R, G and B). Further, one sub-range may be decided by two or more color components. In addition, the total number of sub-ranges is not limited to 4, and an arbitrary plural number may be employed. Moreover, the threshold value of the total number TR of ranges is not limited to 2, and may be 1 or may be equal to or larger than 3.

### D. Fourth Embodiment

Differently from the previous embodiments, the raster data creating unit 112 (FIG. 1) may determine whether the variation of colors is large by using a standard deviation of a gradation value, instead of the total number TC of colors or the total number TR of color ranges.

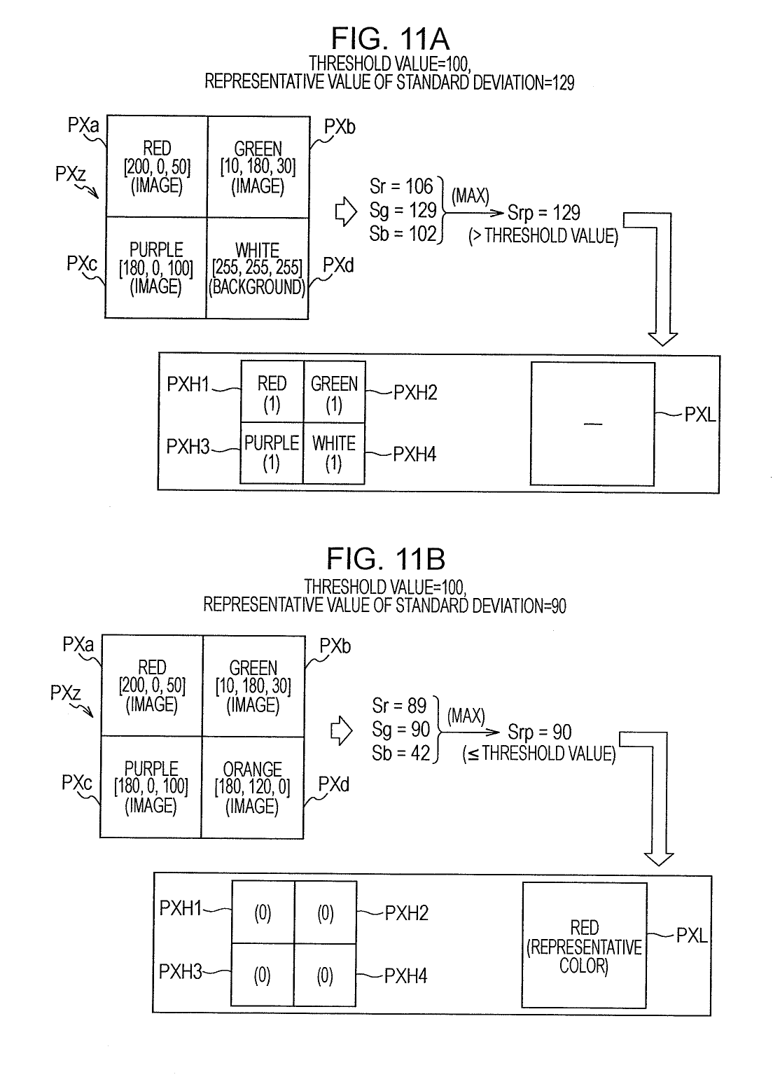

FIG. 11A is a schematic view illustrating an example of determining a pixel value. FIG. 11A illustrates the target low resolution pixel PXz, the four high resolution pixels PXa to PXd, standard deviations Sr, Sg and Sb of gradation values of R, G and B, a representative standard deviation Srp, the high resolution pixels PXH1 to PXH4 and the low resolution pixel PXL. The three high resolution pixels PXa to PXc each represent the object of the image, and the fourth pixel PXd represents the “background”. As described above, the target low resolution pixel PXz does not represent the object of the character but represents the object of the image. Further, the pixel values (R, G and B) of the four high resolution pixels PXa to PXd are [200, 0, 50], [10, 180, 30], [180, 0, 100] and [255, 255, 255], respectively. The standard deviation Sr of red R is “106”, the standard deviation Sg of green G is “129” and the standard deviation Sb of blue B is “102” (the standard deviations denotes standard deviations of gradation values in the four high resolution pixels PXa to PXd). The raster data creating unit 112 calculates the standard deviations Sr, Sg and Sb from high resolution pixels included in the target low resolution pixel PXz, and determines the representative standard deviation Srp. According to the embodiment, the representative standard deviation Srp denotes the maximum value of the three standard deviations Sr, Sg and Sb. When the representative standard deviation Srp is larger than a predetermined threshold value, the raster data creating unit 112 determines that the variation of colors is large. According to the embodiment, the threshold value is 100. In the example of FIG. 11A, the representative standard deviation Srp (129) is larger than the threshold value (100). Thus, the raster data creating unit 112 determines the pixel values of the high resolution pixels PXH1 to PXH4. The determination of these pixel values corresponds to Step S16 of FIG. 2. Further, even in the embodiment, the pixel values of the high resolution pixels PXH1 to PXH4 are determined such that the high resolution pixels PXH1 to PXH4 include plural pixels (at least two pixels) representing colors different from each other.

FIG. 11B is a schematic view illustrating another example of determining a pixel value. The example of FIG. 11B is substantially identical to the example of FIG. 11A, except that the fourth pixel PXd represents the object of the “image” and the gradation value of the fourth pixel PXd is [180, 120. 0]. In such an example, the standard deviation Sr of red R is “89”, the standard deviation Sg of green G is “90” and the standard deviation Sb of blue B is “42”. The representative standard deviation Srp is “90” which is equal to or less than a threshold value (100). Consequently, the raster data creating unit 112 (FIG. 1) determines the gradation value of the low resolution pixel PXL. The determination of the pixel value corresponds to Step S18 of FIG. 2. The gradation value of the pixel PXL is set similarly to the example of FIG. 9B.

Further, there occurs a case in which the target low resolution pixel PXz includes high resolution pixels representing the object of the character and high resolution pixels representing the object of the image. In such a case, similarly to the example of FIG. 7, the raster data creating unit 112 (FIG. 1) may calculate the standard deviation by using the remaining high resolution pixels after excluding the high resolution pixels representing characters.

### E. Fifth Embodiment

Differently from the previous embodiments, the raster data creating unit 112 (FIG. 1) may determine whether the variation of colors is large by using a difference of gradation values, instead of the total number TC of colors, the total number TR of color ranges or the representative standard deviation Srp.

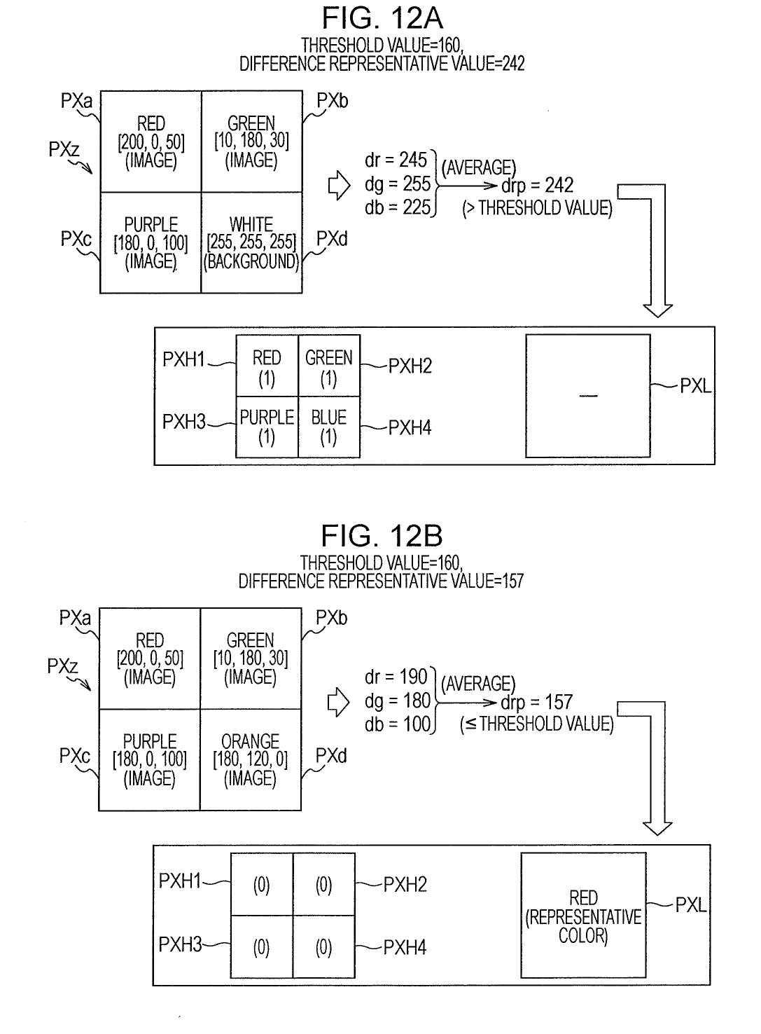

FIG. 12A is a schematic view illustrating an example of determining a pixel value. FIG. 12A illustrates the target low resolution pixel PXz, the four high resolution pixels PXa to PXd, maximum differences dr, dg and db of gradation values of R, G and B, a representative difference drp, the high resolution pixels PXH1 to PXH4 and the low resolution pixel PXL. The four high resolution pixels PXa to PXd are identical to the pixels of the example of FIG. 11A, respectively. The maximum difference dr of red R is “245”, the maximum difference dg of green G is “255” and the maximum difference db of blue B is “225” (the maximum difference is obtained by subtracting the minimum value from the maximum value of the gradation values in the four high resolution pixels PXa to PXd). The raster data creating unit 112 calculates the maximum differences dr, dg and db from high resolution pixels included in the target low resolution pixel PXz, and determines the representative difference drp. According to the embodiment, the representative difference drp is an average value of the three differences dr, dg and db. When the representative difference drp is larger than a predetermined threshold value, the raster data creating unit 112 determines whether the variation of colors is large. According to the embodiment, the threshold value is 160. In the example of FIG. 12A, the representative difference drp (242) is larger than the threshold value (160). Thus, the raster data creating unit 112 determines the pixel values of the high resolution pixels PXH1 to PXH4. The determination of these pixel values corresponds to Step S16 of FIG. 2. Further, even in the embodiment, the pixel values of the high resolution pixels PXH1 to PXH4 are determined such that the high resolution pixels PXH1 to PXH4 include plural pixels (at least two pixels) representing colors different from each other.

FIG. 12B is a schematic view illustrating another example of determining a pixel value. The example of FIG. 12B is substantially identical to the example of FIG. 12A, except that the fourth pixel PXd represents the object of the “image” and the gradation value of the fourth pixel PXd is [180, 120. 0]. In such an example, the maximum difference dr of red R is “190”, the maximum difference dg of green G is “180” and the maximum difference db of blue B is “100”. The representative difference drp is “157” which is equal to or less than a threshold value (160). Consequently, the raster data creating unit 112 (FIG. 1) determines the gradation value of the low resolution pixel PXL. The determination of the pixel value corresponds to Step S18 of FIG. 2. The gradation value of the pixel PXL is set similarly to the example of FIG. 9B.

Further, there occurs a case in which the target low resolution pixel PXz includes high resolution pixels representing the object of the character and high resolution pixels representing the object of the image. In such a case, similarly to the example of FIG. 7, the raster data creating unit 112 (FIG. 1) may calculate the difference of the gradation values by using the remaining high resolution pixels after excluding the high resolution pixels representing characters.

### F. Modification

Since, among elements in the previous embodiments, elements other than elements claimed in the independent claims are additional, the elements may be omitted. Further, the invention is not limited to the previous embodiments and various modifications can be made within the scope of the invention. For example, the following modifications can be made.

### Modification 1

Differently from the previous embodiments, an index value, which represents the magnitude of the variation of colors, is not limited to the total number TC of colors (FIGS. 5 and 6), the total number TR of ranges (FIG. 10), the representative standard deviation Srp (FIG. 11) or the representative difference drp (FIG. 12), and it is possible to employ various values representing the magnitude of the variation of colors. In general, various values representing the extent of a color distribution range can be used as the index value. For example, differently from the previous embodiment, the representative standard deviation Srp may include a value (e.g., an average value, a mode value, a median value, a maximum value or a minimum value) represented by various functions of standard deviations Sr, Sg and Sb. Similarly to this, the representative difference drp may include a value represented by various functions of the maximum differences dr, dg and db. Further, dispersion may be used instead of the standard deviation. Further, it may be possible to employ a value obtained by using gradation values of color components of a part of plural color components representing colors. In addition, the index value may be determined based on pixels of a part of plural high resolution pixels included in one low resolution pixel. For example, the index value may be determined according to a “high resolution pixel located at the left upper corner” and a “high resolution pixel located at the right lower corner” of one low resolution pixel. A pixel determined in advance may be employed as a high resolution pixel of a part of one low resolution pixel.

Further, a method of determining whether the variation of colors is large is not limited to a method of comparing the index value with the threshold value, and various methods can be employed. For example, it may be possible to use a look-up table which represents a correspondence relationship between a combination of colors and a determination result.

### Modification 2

Differently from the previous embodiments, the pixel value determination process, which is performed based on the respective low resolution pixels (e.g., the target low resolution pixel PXz in FIG. 5), can employ various processes according to the type of objects represented by the low resolution pixels (herein, “the fact that a pixel of low resolution represents a certain type of objects” means that the pixel of the low resolution includes pixels of high resolution, which represent the objects of the type). Further, even in relation to a low resolution pixel in which a combination of the types of the represented objects is different from the combination as illustrated in FIGS. 5 to 12, various pixel value determination processes can be employed. For example, when a low resolution pixel represents both an object of a character and an object of an image, pixel values of all high resolution pixels included in the low resolution pixel may be determined regardless of the magnitude of the variation of colors. In addition, in relation to a low resolution pixel representing characters, pixel values of all high resolution pixels included in the low resolution pixel may be determined regardless of whether the low resolution pixel further represents other objects (e.g., vector graphics of an image or a bitmap object). In relation to a low resolution pixel representing plural types of objects, pixel values of all high resolution pixels included in the low resolution pixel may be determined.

### Modification 3

Differently from the previous embodiments, compression/decompression algorithm by the data compression unit 114 (FIG. 1) and the data development unit 222 is not limited to the run length encoding, and various algorithms (e.g., Huffman coding) may be employed. In any case, it is preferred to employ a lossless compression algorithm. Further, an object to be compressed is at least one of the high resolution raster data RDH and the low resolution raster data RDL. For example, both the raster data RDH and RDL may be compressed. Further, such compression elements (the data compression unit 114 and the data development unit 222) may be omitted. In this regard, it is preferred to compress at least one of the raster data RDH and RDL. In this way, although a bandwidth of a data transmission path TL (e.g., the transmission path TL of FIG. 1) is narrow, the raster data RDH and RDL can be transmitted at a high speed. Further, the capacity of a memory area used for storing the raster data can be reduced.

### Modification 4

Differently from the previous embodiments, the input data ID is not limited to the PDL format, and various formats may be employed. For example, raster data may be employed as the input data ID. In such a case, it is preferred that the input data ID includes information representing a correspondence relationship between pixels and the types of objects. Further, when the pixel density of the input data ID is different from the pixel density of the high resolution raster data RDH, it is preferred that the raster data creating unit 112 (FIG. 1) specifies the pixel values (the original raster data RDA) of each pixel of the high resolution through the resolution conversion process of the input data ID.

Further, the resolution of the high resolution raster data RDH may be different from 2400 dpi and the resolution of the low resolution raster data RDL may be different from 1200 dpi. In general, it is preferred that the resolution (the pixel density) of the high resolution raster data RDH is higher than the resolution (the pixel density) of the low resolution raster data RDL. Herein, the resolution in the longitudinal direction may be different from the resolution in the transverse direction. In such a case, in at least one of the longitudinal direction and the transverse direction, it is preferred that the resolution of the high resolution raster data RDH is higher than the resolution of the low resolution raster data RDL. In any one of the longitudinal direction and the transverse direction, the resolution of the high resolution image raster data RDH may be identical to the resolution of the low resolution raster data RDL. In any case, in the respective longitudinal and transverse directions, it is preferred that the resolution (pixel density) of the high resolution raster data RDH is L (L is an integer equal to or larger than 1) times as high as the resolution (pixel density) of the low resolution raster data RDL. Further, the color components of the pixel values are not limited to R, G and B, and may employ other components.

### Modification 5

Differently from the previous embodiments, in relation to an image part in which pixel values have been set in the high resolution raster data RDH, the raster data synthesizing unit 224 (FIG. 1) may select the pixel values of the high resolution raster data RDH. In relation to an image part in which pixel values have not been set in the high resolution raster data RDH, the raster data synthesizing unit 224 (FIG. 1) may select the pixel values of the low resolution raster data RDL. Herein, a method of determining whether the pixel values have been set in the high resolution raster data RDH is not limited to the method using the flag, and various methods may be employed. For example, a specific value of plural values represented by gradation values assigned to pixels may represent that the pixel values have not been set. In general, it is preferred that the raster data creating unit 112 (FIG. 1) creates information (also referred to as “pixel specifying information”) for specifying pixels, in which pixel values have been set, of plural pixels represented by the high resolution raster data RDH. Then, the raster data synthesizing unit 224 may specify the image part, in which pixel values have been set in the pixels of the high resolution raster data RDH, by using the pixel specifying information. The pixel specifying information may employ various formats. For example, a list of identification numbers of pixels, in which pixel values have been set, may be employed. Further, information representing positions of pixels, in which pixel values have been set, may be employed. In any case, data representing gradation values of pixels, in which pixel values have not been set, may be deleted from the raster data RDH and RDL.

### Modification 6

Differently from the previous embodiments, the configuration of an image processing system is not limited to the configuration as illustrated in FIG. 1, and may employ various configurations. For example, a part of the elements of the computer 100 may be provided in the printing apparatus 200. In contrast, a part of the elements of the printing apparatus 200 may be provided in the computer 100. Further, the computer 100 and the printing apparatus 200 may be incorporated in one apparatus. Furthermore, the data compression unit 114 and the data development unit 222 may be omitted. In addition, the raster data synthesizing unit 224 may be provided in an apparatus different from any one of the printing apparatus 200 and the computer 100.

In any case, the image processing apparatus provided with the raster data creating unit 112 creating the raster data RDH and RDL is used, so that it is possible to reduce a problem occurring when using the high resolution raster data RDH and the low resolution raster data RDL. Further, the image processing apparatus provided with the raster data synthesizing unit 224, which synthesizes the raster data RDH and RDL by giving priority to a gradation value specified by the high resolution raster data RDH, is used, so that an image can be reliably reproduced.

Further, the synthesized raster data RDC (FIGS. 1 and 3) is not used only for the purpose of printing, and may be used for various purposes. For example, a display apparatus may display an image according to the synthesized raster data RDC. As described above, it is possible to use various image output units that output (display or print) an image according to the synthesized raster data RDC. The image output unit may be provided separately from the processing apparatus provided with the raster data synthesizing unit 224.

Further, a method of transmitting the raster data RDH and RDL from the raster data creating unit 112 to the raster data synthesizing unit 224 can be implemented in various ways. For example, instead of the transmission path TL (FIG. 1), a detachable memory (e.g., a USB memory) may be used. In such a case, the computer 100 and the printing apparatus 200 may be provided with interfaces to which the memory is connected. Further, the raster data creating unit 112 and the raster data synthesizing unit 224 may be provided in the same apparatus. In such a case, a memory (e.g., a common memory), which can be referred to from both the raster data creating unit 112 and the raster data synthesizing unit 224, may be used.

### Modification 7

Differently from the previous embodiments, a part of the configuration realized by hardware may be replaced with software, and, in contrast, a part or the whole of the configuration realized by software may be replaced with hardware. For example, the function of the raster data creating unit 112 of FIG. 1 may be realized by a hardware circuit provided with a logic circuit.

Further, when a part or the whole of the function of the invention is realized by software, the software (computer program) can be stored in a computer-readable recording medium and provided. According to the invention, the “computer-readable recording medium” is not limited to a portable recording medium such as a flexible disk or a CD-ROM, and may include an internal recording device (e.g., various RAMs and ROMs) in a computer and an external recording device (e.g., a hard disk) fixed to the computer.

The disclosure of Japanese Patent Application No. 2009-033583 filed Feb. 17, 2009 including specification, drawings and claims is incorporated herein by reference in its entirety.

What is claimed is:

1. An image processing apparatus comprising:
a raster data creating unit that creates raster data representing an image including various types of objects in response to input data representing the image,
wherein the raster data includes high resolution raster data of a first pixel density and a low resolution raster data of a second pixel density lower than the first pixel density, and
the raster data creating unit sets any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

2. The image processing apparatus according to claim 1, wherein the raster data creating unit sets the pixel values of the pixels of the high resolution raster data with respect to objects such as characters.

3. The image processing apparatus according to claim 1, wherein the raster data creating unit sets the pixel values of the pixels of the high resolution raster data when an index value indicating magnitude of the variation of the colors is larger than a predetermined threshold value, and sets the pixel values of the pixels of the low resolution raster data when the index value is smaller than the predetermined threshold value.

4. The image processing apparatus according to claim 3, wherein the index value is a total number of the colors in at least a part of the plural pixels of the first pixel density, which correspond to one pixel of the second pixel density.

5. The image processing apparatus according to claim 3, wherein a range of colors represented by the raster data is divided in advance into a plurality of sub-ranges, and
the index value is a total number of sub-ranges including at least one of the colors in at least a part of the plural pixels of the first pixel density, which correspond to one pixel of the second pixel density.

6. The image processing apparatus according to claim 1, further comprising a compression unit that compresses the high resolution raster data.

7. The image processing apparatus according to claim 1, wherein, in the high resolution raster data, at least two of the plural pixels, which correspond to one pixel of the second pixel density, represent colors different from each other.

8. A printing apparatus that performs printing based on the raster data created by the image processing apparatus according to claim 1.

9. A method of creating raster data comprising:
creating the raster data representing an image including plural types of objects in response to input data representing the image,
wherein the raster data includes high resolution raster data of a first pixel density and a low resolution raster data of a second pixel density lower than the first pixel density, and
the creating of the raster data includes setting any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.

10. A computer program product that causes a computer to execute a process of creating raster data, the computer program product causing the computer to execute a function of creating the raster data representing an image including plural types of objects in response to input data representing the image,
wherein the raster data includes high resolution raster data of a first pixel density and a low resolution raster data of a second pixel density lower than the first pixel density, and
the function of creating the raster data includes setting any one of pixel values of pixels of the high resolution raster data and pixel values of pixels of the low resolution raster data in an image area of objects of a type other than characters based on variation of colors of the image area represented by a plurality of pixels of the first pixel density, which correspond to one pixel of the second pixel density.
